(19) United States
(12) Patent Application Publication
(10) Pub. No.: US 2017/0260446 A1
(43) Pub. Date: Sep. 14, 2017

(54) METHOD FOR PRODUCING VANADIUM DIOXIDE-CONTAINING PARTICLE AND DISPERSION

(71) Applicant: Konica Minolta, Inc., Tokyo (JP)

(72) Inventor: Takashi WASHIZU, Hachioji-shi, Tokyo (JP)

(21) Appl. No.: 15/329,809

(22) PCT Filed: Jul. 28, 2015
(86) PCT No.: PCT/JP2015/071302

§ 371 Date: Jan. 27, 2017

(30) Foreign Application Priority Data
Jul. 30, 2014 (JP) 2014-154406

(51) Int. Cl. C09K 9/00; C01G 31/02; C09C 3/08; C09C 1/00; C09C 3/12

(52) U.S. Cl. CPC C09K 9/00; C09C 1/00; C09C 3/12; C09C 3/08; C01G 31/02; C01P 2004/64; C01P 2004/51; C01P 2006/60; B82Y 20/00

(57) ABSTRACT

An object of the present invention is to provide a method for producing a vanadium dioxide-containing particle that is excellent in the thermochromic property and the transparency. The method for producing a vanadium dioxide-containing particle of the present invention is a method for producing a vanadium dioxide-containing particle having a thermochromic property by using a hydrothermal reaction, and is characterized by surface-modifying a surface of the vanadium dioxide-containing particle without separating a solvent and the vanadium dioxide-containing particle.

### TECHNICAL FIELD

The present invention relates to a method for producing a vanadium dioxide-containing particle, and to a dispersion. More specifically, the present invention relates to a method for producing a vanadium dioxide-containing particle that is excellent in the thermochromic property and the transparency, and to a dispersion.

### BACKGROUND ART

Vanadium dioxide (VO₂) has been receiving attention as a material showing a thermochromic phenomenon in which optical properties such as transmittance and reflectivity reversibly change by temperature change.

In a crystal structure of the vanadium dioxide, there are several polymorphs of a crystal phases such as a phase A, a phase B, a phase C, and a phase R (so-called a “rutile crystal phase”). Among them, a crystal structure showing the thermochromic property described above is limited to a phase R. This phase R does not show the thermochromic property at the transition temperature or lower, and has a monoclinic structure, therefore, is also called a phase M.

As a technique of preparing such a particle, a hydrothermal synthesis method has been reported (for example, see Patent Literature 1).

In order to obtain an excellent thermochromic property and excellent transparency, the particle diameter is required to be as uniform and small as possible, but it is difficult to prevent the aggregation of particles.

In addition, the synthesized vanadium dioxide particle has an excellent thermochromic property, but is structurally unstable. The vanadium dioxide after the synthesis is easily oxidized and changed to divanadium pentoxide (V₂O₅) or the like, and loses the thermochromic property.

In Patent Literatures 1 and 2, a technique of preventing deterioration or aggregation of particles by surface-modifying a surface of a vanadium dioxide particle has been disclosed. However, in the wet surface modification method generally used, which has been disclosed in Patent Literatures 1 and 2, the particles are surface-modified after passing through a drying process, therefore, vanadium dioxide is extremely unstable, and as a result, the deterioration has already progressed or the aggregation has already been generated before performing the surface modification, and thus the surface modification cannot be sufficiently performed.

In addition, also in Patent Literature 3, a technique of preventing deterioration of particles by performing surface modification has been disclosed, but the surface modification is performed by dispersing the vanadium dioxide powder again, therefore, the particles are aggregated at the time of the powder, and it can be considered that the dispersion is insufficient.

Further, as disclosed in the above-described Patent Literatures or the like, in a case where the particle that has once passed through a drying process is surface-modified, there has been a problem that when the particle is broken, part that has not been surface-modified is exposed, and the thermochromic property cannot be sufficiently exerted.

### CITATION LIST

### Patent Literature

Patent Literature 1: JP 2011-178825 A

Patent Literature 2: JP 2010-31235 A

Patent Literature 3: JP 2013-75806 A

### SUMMARY OF INVENTION

### Technical Problem

The present invention has been made in view of the above problems and situations, and an object of the present invention is to provide a method for producing a vanadium dioxide-containing particle that is excellent in the thermochromic property and the transparency, and a dispersion.

### Solution to Problem

In order to solve the problems described above, the present inventors found, in the process of investigating the cause and the like of the problems described above, that a method for producing a vanadium dioxide-containing particle that is excellent in the thermochromic property and the transparency can be provided by producing a vanadium dioxide-containing particle by a hydrothermal reaction, and surface-modifying a surface of the vanadium dioxide-containing particle without separating a solvent and the vanadium dioxide-containing particle; and thus have completed the present invention.

That is, the problems according to the present invention can be solved by the following means.

1. A method for producing a vanadium dioxide-containing particle having a thermochromic property by using a hydrothermal reaction, the method including

surface-modifying a surface of the vanadium dioxide-containing particle without separating a solvent and the vanadium dioxide-containing particle.

2. The method for producing a vanadium dioxide-containing particle according to the first aspect of the present invention, the method including the successive steps of:

preparing a vanadium compound, a reducing agent, water, and a surface modifier; and

mixing the vanadium compound, the reducing agent, the water, and the surface modifier, and producing the vanadium dioxide-containing particle surface-modified by a hydrothermal reaction.

3. The method for producing a vanadium dioxide-containing particle according to the first aspect of the present invention, the method including the successive steps of:

preparing a vanadium compound, a reducing agent, and water;

mixing the vanadium compound, the reducing agent, and the water, and producing the vanadium dioxide-containing particle by a hydrothermal reaction;

returning a reaction system to room temperature, and then mixing a surface modifier to the reaction system, and surface-modifying a surface of the vanadium dioxide-containing particle.

4. The method for producing a vanadium dioxide-containing particle according to the first aspect of the present invention, the method including the successive steps of:

preparing a vanadium compound, a reducing agent, and water;

mixing the vanadium compound, the reducing agent, and the water, and producing the vanadium dioxide-containing particle by a hydrothermal reaction;

returning a reaction system to room temperature, and then replacing a solvent by ultrafiltration; and

mixing a surface modifier to the reaction system, and surface-modifying a surface of the vanadium dioxide-containing particle.

5. The method for producing a vanadium dioxide-containing particle according to any one of the second to fourth aspects of the present invention, in which the number of reactive groups of the surface modifier is 1 or 2.

6. A dispersion including a vanadium dioxide-containing particle, in which the vanadium dioxide-containing particle is produced by the method for producing a vanadium dioxide-containing particle according to any one of the first to fifth aspects of the present invention.

### Advantageous Effects of Invention

According to the above-described means, a method for producing a vanadium dioxide-containing particle that is excellent in the thermochromic property and the transparency, and a dispersion can be provided.

The development mechanism and action mechanism of the effects of the present invention have not been clarified, but are presumed as follows.

The vanadium dioxide-containing particle according to the present invention is produced by a hydrothermal reaction, a surface of the vanadium dioxide-containing particle is surface-modified without separating a solvent and the vanadium dioxide-containing particle, therefore, the surface modification can be realized without aggregating the particles.

Accordingly, it is considered that as compared with the surface modification performed by the above-described known techniques (see, Patent Literatures 1 to 3), the deterioration of the particle (oxidation of vanadium dioxide) can be largely prevented, and the particle diameter can be made smaller and further the particle diameter distribution can be made narrower.

### DESCRIPTION OF EMBODIMENTS

The method for producing a vanadium dioxide-containing particle of the present invention is a method for producing a vanadium dioxide-containing particle having a thermochromic property by using a hydrothermal reaction, and is characterized by surface-modifying a surface of the vanadium dioxide-containing particle without separating a solvent and the vanadium dioxide-containing particle. These characteristics are technical features common to the inventions according to claims 1 to 6.

As an embodiment of the present invention, the method for producing a vanadium dioxide-containing particle includes the successive steps of: preparing a vanadium compound, a reducing agent, water, and a surface modifier; and mixing the vanadium compound, the reducing agent, the water, and the surface modifier, and producing the vanadium dioxide-containing particle surface-modified by a hydrothermal reaction. Accordingly, the method is not passed through a drying process and the surface modification can be favorably performed, and further, the surface of a particle is covered by a coupling agent until the particle grows to a certain level, and as a result of which the particle diameter becomes smaller and the particle diameter distribution also becomes narrower. Therefore, the method is preferred.

In addition, the method for producing a vanadium dioxide-containing particle includes the successive steps of: preparing a vanadium compound, a reducing agent, and water; mixing the vanadium compound, the reducing agent, and the water, and producing the vanadium dioxide-containing particle by a hydrothermal reaction; and returning a reaction system to room temperature, and then mixing a surface modifier to the reaction system, and surface-modifying a surface of the vanadium dioxide-containing particle. Accordingly, a particle can be subjected to the surface modification without passing through a drying process or a separating process, and the particle can obtain a favorable surface modification state without generating any deterioration. Therefore, the method is preferred. Further, because the reaction temperature and the like can be freely selected in the surface modification process, many kinds of surface modifiers can be used. Therefore, the method is preferred.

In addition, the method for producing a vanadium dioxide-containing particle includes the successive steps of: preparing a vanadium compound, a reducing agent, and water; mixing the vanadium compound, the reducing agent, and the water, and producing the vanadium dioxide-containing particle by a hydrothermal reaction; returning a reaction system to room temperature, and then replacing a solvent by ultrafiltration; and mixing a surface modifier to the reaction system, and surface-modifying a surface of the vanadium dioxide-containing particle. Accordingly, by replacing a solvent after the reaction, the surface modification can be performed in a reaction system in which an organic solvent has been mixed. Therefore, the method is preferred. Further, because the residue can also be removed, the surface modification reaction is hardly inhibited. Therefore, the method is preferred.

In addition, because the reaction only between surface modifiers is suppressed, and generation of by-products is prevented, the number of reactive groups of the surface modifier is preferably 1 or 2.

In addition, the vanadium dioxide-containing particle produced by the method for producing a vanadium dioxide-containing particle of the present invention can be suitably utilized as a dispersion.

Hereinafter, the present invention and the constituents, and the embodiment for carrying out the present invention will be described in detail. Further, in the present application, the expression “to” representing a numerical range is used with the meaning of including the numerical values described before and after the “to” as the lower limit value and the upper limit value, respectively.

<<Method for Producing a Vanadium Dioxide-Containing Particle>>

The method for producing a vanadium dioxide-containing particle having a thermochromic property of the present invention is characterized in that a vanadium dioxide-containing particle is produced by a hydrothermal reaction, and a surface of the vanadium dioxide-containing particle is surface-modified without separating a solvent and the vanadium dioxide-containing particle.

In a production process of a vanadium dioxide-containing particle, when filtration, centrifugation, drying, and the like are performed before surface-modifying a particle surface, particles are aggregated.

As described above, once the particles are aggregated, it is difficult to disperse the particles again in a solvent, the substantial particle diameter becomes large, and the decrease of the transmittance and the decrease of the thermochromic property are generated. In addition, in the part where particles are aggregated and in close contact with each other, the surface modification is not performed, therefore, a processing for preventing the deterioration cannot be performed, and the decrease of the durability is also generated.

That is, in the present invention, “a surface of the vanadium dioxide-containing particle is surface-modified without separating a solvent and the vanadium dioxide-containing particle” means a surface of the vanadium dioxide-containing particle is surface-modified without passing through a process such as drying.

Hereinafter, the case where the surface modification is performed at the same time as the synthesis by a hydrothermal reaction (hereinafter, also referred to as “hydrothermal synthesis”), and the case where the surface modification is performed after the synthesis by a hydrothermal reaction will be described separately.

In addition, in the present invention, the room temperature means in the temperature range of 20 to 30° C.

<Surface Modification at the Time of Hydrothermal Synthesis>

A method for producing a vanadium dioxide-containing particle having a thermochromic property of the present invention, that is, a rutile vanadium dioxide-containing particle will be described.

In the present invention, by reducing and surface-modifying a vanadium compound under a hydrothermal reaction, a surface-modified rutile vanadium dioxide-containing particle is synthesized.

For more details, a vanadium compound, a reducing agent, and a surface modifier are mixed with water, and the resultant mixture is subjected to hydrothermal synthesis in the range of 200 to 270° C. in an autoclave. At this time, hydrogen peroxide may be mixed into the autoclave.

The reaction time varies depending on the temperature, therefore, is determined by confirming the progress of the reaction.

After the reaction, the temperature is cooled down to room temperature, and the obtained product is separated from a solvent by centrifugation or filtration.

After that, ethanol or water is added to the separated product to disperse the separated product again, and then a solvent and particles are separated, and thus the washing is performed.

The above-described processes are repeated several times, and then by drying the resultant product in a vacuum oven, for example, at 60° C. for (24 hours), a surface-modified vanadium dioxide-containing particle can be obtained.

The vanadium dioxide-containing particle may be dispersed in a predetermined solvent (dispersion medium), and used as a dispersion. As the dispersion medium, it is not particularly limited, and a known dispersion medium can be used.

<Surface Modification After Hydrothermal Synthesis>

A method for producing a vanadium dioxide-containing particle having a thermochromic property of the present invention, that is, a rutile vanadium dioxide-containing particle will be described.

In the present invention, by reducing a vanadium compound under a hydrothermal reaction, a rutile vanadium dioxide-containing particle is synthesized.

For more details, a vanadium compound, and a reducing agent are mixed with water, and the resultant mixture is subjected to hydrothermal synthesis in the range of 200 to 270° C. in an autoclave. At this time, hydrogen peroxide may be mixed into the autoclave.

The reaction time varies depending on the temperature, therefore, is determined by confirming the progress of the reaction.

After the reaction, the temperature is cooled down to room temperature, and into the cooled mixture, a surface modifier is mixed, and then the resultant mixture is stirred at room temperature, and the surface modification reaction is allowed to proceed. At this time, by using ultrafiltration, a solvent is replaced, and washing is performed, and then a surface modifier is added, and the reaction may be allowed to proceed.

The obtained product is separated from a solvent by centrifugation or filtration.

After that, ethanol or water is added to the separated product to disperse the separated product again, and then a solvent and particles are separated, and thus the washing is performed.

The above-described processes are repeated several times, and then the resultant product is dried in a vacuum oven, for example, at 110° C. (for one hour), and a surface-modified vanadium dioxide-containing particle can be obtained.

The vanadium dioxide-containing particle may be dispersed in a predetermined solvent (dispersion medium), and used as a dispersion. As the dispersion medium, it is not particularly limited, and a known dispersion medium can be used.

(Ultrafiltration)

As to the ultrafiltration, for example, by using VIVAFLOW 50 manufactured by Sartorius Stedim (effective filtration area of 50 cm², and fraction molecular weight of 5000), the filtration can be performed at room temperature, at a flow rate of 300 ml/min, and at a liquid pressure of 1 bar (0.1 MPa).

<Surface Modification>

As the method of surface modification using a surface modifier, a wet heating method is preferred. When the wet heating method is used, particles can be processed from a water dispersion state without turning into a gel after synthesis.

In this case, from a water dispersion state of particles, by the addition of 2 to 100 parts by mass of water based on one part by mass of particles and a surface modifier to the particles, and by the heating of the resultant mixture at a predetermined temperature for a predetermined time, the particle surface can be surface-modified.

At this time, when the amount of water is excessive, the water may be removed by using an evaporator or the like before the addition of an organic dispersion medium.

When the mixing of a surface modifier is insufficient, an organic solvent may be mixed into water. The organic dispersion medium to be used is not particularly limited, and for example, a dispersion medium such as methanol, ethanol, isopropyl alcohol, ethoxyethanol, dimethylformamide, acetone, ethyl acetate, tetrahydrofuran, benzene, toluene, hexane, xylene, and cyclohexane can be appropriately used alone or in a mixture of two or more kinds thereof as needed. As the dispersion medium, it is preferred to use isopropyl alcohol.

In addition, in order to proceed with the surface modification reaction, the pH may be adjusted as needed. The pH of the reaction mixture is adjusted in the range (25° C.) of preferably 9 to 12, and more preferably in the range of 10 to 11 from the viewpoint of the stability of the dispersed particles. As a reagent for adjusting the pH, ammonia, ammonium acetate, ammonium bicarbonate, ammonium carbonate, trimethylamine, pyridine, aniline, or the like can be preferably used, but because of being easily removed by heating after particle formation, ammonia is preferably used.

<<Vanadium Dioxide Particle>>

The vanadium dioxide-containing particle according to the present invention is a particle containing at least vanadium dioxide. The vanadium dioxide-containing particle may contain a component other than the vanadium dioxide in the particle, or may be formed of only vanadium dioxide.

In addition, the vanadium dioxide-containing particle according to the present invention has transparency (transparency in the visible light range of a film with a vanadium dioxide-containing particle added), and a thermochromic property.

As the transmittance of the vanadium dioxide-containing particle according to the present invention, the higher the better, and the transmittance is preferably 70% or more.

Further, the thermochromic property of the vanadium dioxide-containing particle is not particularly limited as long as the optical properties such as transmittance and reflectivity reversibly change by temperature change. For example, it is preferred that the transmittance difference between at 25° C./50% RH and at 85° C./85% RH is 30% or more.

The transmittance of the vanadium dioxide-containing particle can be measured as the transmittance at a wavelength of 2000 nm, for example, by using a spectrophotometer V-670 (manufactured by JASCO Corporation).

In addition, the particle diameter of the vanadium dioxide-containing particle according to the present invention is preferably 100 nm or less, and more preferably 50 nm or less, in order to obtain excellent transparency and an excellent thermochromic property.

Further, the particle diameter in the present invention means a value of D50 measured by a laser diffraction particle size analyzer.

<<Vanadium Compound>>

As the vanadium compound according to the present invention, it is not particularly limited, and examples of the vanadium compound include vanadium alkoxide, divanadium pentoxide, and ammonium vanadate.

<<Reducing Agent>>

As the reducing agent according to the present invention, it is not particularly limited, and examples of the reducing agent include hydrazine or a hydrate thereof, a sulfite, oxalic acid, and sodium borohydride.

<<Surface Modifier>>

Examples of the surface modifier according to the present invention include, for example, an organic silicon compound, an organic titanium compound, an organic aluminum compound, an organic zirconia compound, a surfactant, and a silicone oil.

The number of reactive groups of the surface modifier is preferably 1 or 2.

Examples of the organic silicon compound (organic silicate compound) used as a surface modifier include, for example, hexamethyldisilazane, trimethylethoxysilane, trimethylmethoxysilane, tetraethoxysilane, trimethylsilyl chloride, methyltriethoxysilane, dimethyldiethoxysilane, decyltrimethoxysilane, vinyltrichlorosilane, vinyltrimethoxysilane, vinyltriethoxysilane, N-(2-aminoethyl)-3-aminopropyltriethoxysilane, 3-aminopropyltriethoxysilane, 3-phenylaminopropyltrimethoxysilane, 3-mercaptopropyl methyl dimethoxy silane, 2-(3,4-epoxycyclohexyl)ethyltrimethoxysilane, and 3-glycidoxypropylmethyldimethoxysilane. Further, as the one available on the market, for example, SZ6187 (manufactured by Dow Corning Toray Silicone Co., Ltd.), or the like can be suitably used.

Among them, an organic silicate compound having a small molecular weight and showing high durability is desirably used, and hexamethyldisilazane, tetraethoxysilane, trimethylethoxysilane, trimethylmethoxysilane, and trimethylsilyl chloride are preferably used.

Examples of the organic titanium compound include, for example, tetrabutyl titanate, tetraoctyl titanate, tetraisopropyl titanate, tetra-n-butyl titanate, butyl titanate dimer, isopropyltriisostearoyl titanate, isopropyltridecylbenzenesulfonyl titanate, and bis(dioctylpyrophosphate)oxyacetate titanate; and examples of the chelate compound include titanium acetylacetonate, titanium tetraacetylacetonate, titanium ethylacetoacetate, a titanium phosphate compound, titanium octylene glycolate, titanium ethylacetoacetate, a titanium lactate ammonium salt, titanium lactate, and titanium triethanolaminate. Further, as the one available on the market, for example, Plenact TTS (manufactured by Ajinomoto Fine-Techno Co., Inc.), Plenact TTS44 (manufactured by Ajinomoto Fine-Techno Co., Inc.), and the like can be mentioned.

Examples of the organic aluminum compound include, for example, aluminum isopropoxide, and aluminum tert-butoxide.

Examples of the organic zirconia compound include, for example, n-propyl zirconate, n-butyl zirconate, zirconium tetraacetylacetonate, zirconium monoacetylacetonate, and zirconium tetraacetylacetonate.

The surfactant is a compound having a hydrophilic group and a hydrophobic group in the same molecule.

Specific examples of the hydrophilic group of a surfactant include a hydroxy group, a hydroxyalkyl group having one or more carbon atoms, a hydroxyl group, a carbonyl group, an ester group, an amino group, an amide group, an ammonium salt, thiol, a sulfonate, a phosphate, and a polyalkylene glycol group. Herein, the amino group may be any one of the primary, secondary, and tertiary amino groups.

Specific examples of the hydrophobic group of a surfactant include an alkyl group, a silyl group having an alkyl group, and a fluoroalkyl group. Herein, the alkyl group may have an aromatic ring as a substituent.

It is sufficient for the surfactant to have at least one of the hydrophilic groups described above and at least one of the hydrophobic groups described above in the same molecule, and the surfactant may have two or more groups of the hydrophilic groups and two or more groups of the hydrophobic groups.

More specific examples of the surfactant include myristyl diethanolamine, 2-hydroxyethyl-2-hydroxydodecylamine, 2-hydroxyethyl-2-hydroxytridecylamine, 2-hydroxyethyl-2-hydroxytetradecylamine, pentaerythritol monostearate, pentaerythritol distearate, pentaerythritol tristearate, di-2-hydroxyethyl-2-hydroxydodecylamine, alkyl(having 8 to 18 carbon atoms)benzyldimethylammonium chloride, ethylenebisalkyl (having 8 to 18 carbon atoms)amide, stearyl diethanolamide, lauryl diethanolamide, myristyl diethanolamide, palmityl diethanolamide, perfluoroalkenyl, and a perfluoroalkyl compound.

Examples of the silicone oil include, for example, a straight silicone oil such as a dimethyl silicone oil, a methyl phenyl silicone oil, and a methylhydrogen silicone oil; and a modified silicone oil such as an amino-modified silicone oil, an epoxy-modified silicone oil, a carboxyl-modified silicone oil, a carrbinol-modified silicone oil, a methacrylic-modified silicone oil, a mercapto-modified silicone oil, a different functional group-modified silicone oil, a polyether-modified silicone oil, a methylstyryl-modified silicone oil, a hydrophilic special-modified silicone oil, a higher alkoxy-modified silicone oil, a modified silicone oil having a higher fatty acid, and a fluorine-modified silicone oil.

The above-described surface modifier may be used by being appropriately diluted with, for example, hexane, toluene, methanol, ethanol, acetone, or water.

In addition, the number of carbon atoms in an organic functional group that is introduced by the above-described surface modifier is preferably 1 to 6. According to this, the durability can be improved.

The amount of the surface modifier is preferably in the range of 0.1 to 30% by mass of the particle, and from the viewpoint of the durability, is preferably 0.1 to 10% by mass. When the amount of the surface modifier is 30% by mass or less, the proportion of the organic part is small and the durability is not deteriorated, and when the amount of the surface modifier is 0.1% by mass or more, the particle surface can be sufficiently surface-modified.

### EXAMPLES

Hereinafter, the present invention is specifically explained using Examples, however, the present invention is not limited to the following Examples. In addition, the expression of “%” is used in Examples, and the “%” represents “% by mass” unless otherwise specified.

<<Preparation of Vanadium Dioxide-Containing Particle>>

(1) Preparation of Vanadium Dioxide-Containing Particle 101

A particle is prepared with reference to the technique described in Example 4 of Patent Literature 1.

Specifically, into 15 g of pure water, 0.6 g of ammonium metavanadate (NH₄VO₃, manufactured by Wako Pure Chemical Industries, Ltd.) was mixed, and the resultant mixture was stirred at room temperature (25° C.) for 15 minutes.

Next, a 5% by mass aqueous solution of hydrazine monohydrate (N₂H₄.H₂O, special grade, manufactured by Wako Pure Chemical Industries, Ltd.) was slowly added dropwise, and a solution having a pH value (25° C.) of 9.0 was prepared.

The prepared solution was put into a high pressure reaction decomposition vessel stationary-type HU 50 ml set (an outer casing made of pressure-resistant stainless steel, and a sample container made of PTFE, HUTc-50, manufactured by SAN-AI Kagaku Co. Ltd.), and heated at 100° C. for 8 hours, and then the resultant product was subjected to a hydrothermal reaction treatment at 270° C. for 24 hours.

The obtained product was separated by using centrifugation, and then ethanol was further added to the product, and the resultant mixture was stirred, and centrifuged.

By further performing the operation repeatedly in the order of water, and ethanol, the product was washed.

The washed product was dried at 60° C. for 24 hours in a vacuum oven, and vanadium dioxide (VO₂) was produced.

Next, into a solution obtained by mixing 20 ml of ethanol and 5 ml of pure water, ammonia water (28% by mass, manufactured by Wako Pure Chemical Industries, Ltd.) was added, and a solution having a pH value of 11.5 was prepared. Into this solution, 1 g of the prepared vanadium dioxide-containing particle and 0.3 g of methyltriethoxysilane (manufactured by TOKYO CHEMICAL INDUSTRY CO., LTD.) was added, and the resultant mixture was stirred and mixed at 30° C. for 4 hours.

The obtained suspension was subjected sequentially to filtration and washing, and fine particles were recovered.

The recovered fine particles were subjected to a drying treatment at 110° C. for one hour, and a surface-modified vanadium dioxide-containing particle 101 was obtained.

(2) Preparation of Vanadium Dioxide-Containing Particle 102

Into 15 g of pure water, 0.6 g of ammonium metavanadate (NH₄VO₃, manufactured by Wako Pure Chemical Industries, Ltd.) was mixed, and the resultant mixture was stirred at room temperature (25° C.) for 15 minutes.

Next, a 5% by mass aqueous solution of hydrazine monohydrate (N₂H₄.H₂O, special grade, manufactured by Wako Pure Chemical Industries, Ltd.) was slowly added dropwise, and a solution having a pH value (25° C.) of 9.0 was prepared.

A mixture obtained by mixing 0.03 g of methyltriethoxysilane (manufactured by TOKYO CHEMICAL INDUSTRY CO., LTD.) into the prepared solution was put into a high pressure reaction decomposition vessel stationary-type HU 50 ml set (an outer casing made of pressure-resistant stainless steel, and a sample container made of PTFE, HUTc-50, manufactured by SAN-AI Kagaku Co. Ltd.), and heated at 100° C. for 8 hours, and then the resultant product was subjected to a hydrothermal reaction treatment at 270° C. for 24 hours.

The obtained product was separated by using centrifugation, and then ethanol was further added to the product, and the resultant mixture was stirred, and centrifuged.

By further performing the operation repeatedly in the order of water, and ethanol, the product was washed, and fine particles were recovered.

The recovered fine particles were subjected to a drying treatment at 110° C. for one hour, and a surface-modified vanadium dioxide-containing particle 102 was obtained.

(3) Preparation of Vanadium Dioxide-Containing Particle 103

Into 15 g of pure water, 0.6 g of ammonium metavanadate (NH₄VO₃, manufactured by Wako Pure Chemical Industries, Ltd.) was mixed, and the resultant mixture was stirred at room temperature (25° C.) for 15 minutes.

Next, a 5% by mass aqueous solution of hydrazine monohydrate (N₂H₄.H₂O, special grade, manufactured by Wako Pure Chemical Industries, Ltd.) was slowly added dropwise, and a solution having a pH value (25° C.) of 9.0 was prepared.

The prepared solution was put into a high pressure reaction decomposition vessel stationary-type HU 50 ml set (an outer casing made of pressure-resistant stainless steel, and a sample container made of PTFE, HUTc-50, manufactured by SAN-AI Kagaku Co. Ltd.), and heated at 100° C. for 8 hours, and then the resultant product was subjected to a hydrothermal reaction treatment at 270° C. for 24 hours.

After the reaction, the resultant mixture was cooled down to room temperature (25° C.), and then into the mixture, 0.03 g of methyltriethoxysilane (manufactured by TOKYO CHEMICAL INDUSTRY CO., LTD.) was added, and the resultant mixture was stirred at 30° C. for 24 hours.

The obtained product was separated by using centrifugation, and then ethanol was further added to the product, and the resultant mixture was stirred, and centrifuged.

By further performing the operation repeatedly in the order of water, and ethanol, the product was washed, and fine particles were recovered.

The recovered fine particles were subjected to a drying treatment at 110° C. for one hour, and a surface-modified vanadium dioxide-containing particle 103 was obtained.

(4) Preparation of Vanadium Dioxide-Containing Particle 104

Into 15 g of pure water, 0.6 g of ammonium metavanadate (NH₄VO₃, manufactured by Wako Pure Chemical Industries, Ltd.) was mixed, and the resultant mixture was stirred at room temperature (25° C.) for 15 minutes.

Next, a 5% by mass aqueous solution of hydrazine monohydrate (N₂H₄.H₂O, special grade, manufactured by Wako Pure Chemical Industries, Ltd.) was slowly added dropwise, and a solution having a pH value (25° C.) of 9.0 was prepared.

The prepared solution was put into a high pressure reaction decomposition vessel stationary-type HU 50 ml set (an outer casing made of pressure-resistant stainless steel, and a sample container made of PTFE, HUTc-50, manufactured by SAN-AI Kagaku Co. Ltd.), and heated at 100° C. for 8 hours, and then the resultant product was subjected to a hydrothermal reaction treatment at 270° C. for 24 hours.

After the reaction, the temperature is cooled down to room temperature (25° C.), by using VIVAFLOW 50 manufactured by Sartorius Stedim (effective filtration area of 50 cm², and fraction molecular weight of 5000), the filtration was performed at a flow rate of 300 ml/min and at a liquid pressure of 1 bar (0.1 MPa), and the washing was performed.

Into the dispersion after the washing, 0.03 g of methyltriethoxysilane (manufactured by TOKYO CHEMICAL INDUSTRY CO., LTD.) was added, and the resultant mixture was stirred at 30° C. for 24 hours.

The obtained product was separated by using centrifugation, and then ethanol was further added to the product, and the resultant mixture was stirred, and centrifuged.

By further performing the operation repeatedly in the order of water, and ethanol, the product was washed, and fine particles were recovered.

The recovered fine particles were subjected to a drying treatment at 110° C. for one hour, and a surface-modified vanadium dioxide-containing particle 104 was obtained.

(5) Preparation of Vanadium Dioxide-Containing Particle 105

A vanadium dioxide-containing particle 105 was prepared in the similar manner as in the preparation of vanadium dioxide-containing particle 102 except that the methyltriethoxysilane was changed to dimethyldiethoxysilane (manufactured by TOKYO CHEMICAL INDUSTRY CO., LTD.).

(6) Preparation of Vanadium Dioxide-Containing Particle 106

A vanadium dioxide-containing particle 106 was prepared in the similar manner as in the preparation of vanadium dioxide-containing particle 104 except that the methyltriethoxysilane was changed to dimethyldiethoxysilane (manufactured by TOKYO CHEMICAL INDUSTRY CO., LTD.).

(7) Preparation of Vanadium Dioxide-Containing Particle 107

Into an aqueous solution obtained by mixing 2 ml of 35% by mass hydrogen peroxide water (manufactured by Wako Pure Chemical Industries, Ltd.) and 20 ml of pure water, 0.5 g of divanadium pentoxide (V) (V₂O₅, special grade, manufactured by Wako Pure Chemical Industries, Ltd.) was added, and the resultant mixture was stirred at 30° C. for 4 hours, and then into the resultant mixture, a 5% by mass aqueous solution of hydrazine monohydrate (N₂H₄.H₂O, manufactured by Wako Pure Chemical Industries, Ltd.) was slowly added dropwise, and a solution having a pH value (25° C.) of 4.2 was prepared.

A mixture obtained by mixing 0.025 g of methyltriethoxysilane (manufactured by TOKYO CHEMICAL INDUSTRY CO., LTD.) into the prepared mixture was put into a high pressure reaction decomposition vessel stationary-type HU 50 ml set (an outer casing made of pressure-resistant stainless steel, and a sample container made of PTFE, HUTc-50, manufactured by SAN-AI Kagaku Co. Ltd.), and heated at 100° C. for 8 hours, and then the resultant product was subjected to a hydrothermal reaction treatment at 270° C. for 48 hours.

The obtained product was separated by using centrifugation, and then ethanol was further added to the product, and the resultant mixture was stirred, and centrifuged.

By further performing the operation repeatedly in the order of water, and ethanol, the product was washed, and fine particles were recovered.

The recovered fine particles were subjected to a drying treatment at 110° C. for one hour, and a surface-modified vanadium dioxide-containing particle 107 was obtained.

(8) Preparation of Vanadium Dioxide-Containing Particle 108

Into an aqueous solution obtained by mixing 2 ml of 35% by mass hydrogen peroxide water (manufactured by Wako Pure Chemical Industries, Ltd.) and 20 ml of pure water, 0.5 g of divanadium pentoxide (V) (V₂O₅, special grade, manufactured by Wako Pure Chemical Industries, Ltd.) was added, and the resultant mixture was stirred at 30° C. for 4 hours, and then into the resultant mixture, a 5% by mass aqueous solution of hydrazine monohydrate (N₂H₄.H₂O, manufactured by Wako Pure Chemical Industries, Ltd.) was slowly added dropwise, and a solution having a pH value (25° C.) of 4.2 was prepared.

The prepared solution was put into a high pressure reaction decomposition vessel stationary-type HU 50 ml set (an outer casing made of pressure-resistant stainless steel, and a sample container made of PTFE, HUTc-50, manufactured by SAN-AI Kagaku Co. Ltd.), and heated at 100° C. for 8 hours, and then the resultant product was subjected to a hydrothermal reaction treatment at 270° C. for 24 hours.

After the reaction, the temperature is cooled down to room temperature (25° C.), and by performing filtration at a flow rate of 300 ml/min and at a liquid pressure of 1 bar (0.1 MPa) using VIVAFLOW 50 manufactured by Sartorius Stedim (effective filtration area of 50 cm², and fraction molecular weight of 5000), the washing was performed.

Into the dispersion after the washing, 0.025 g of methyltriethoxysilane (manufactured by TOKYO CHEMICAL INDUSTRY CO., LTD.) was added, and the resultant mixture was stirred at 30° C. for 24 hours.

The obtained product was separated by using centrifugation, and then ethanol was further added to the product, and the resultant mixture was stirred, and centrifuged.

By further performing the operation repeatedly in the order of water, and ethanol, the product was washed, and fine particles were recovered.

The recovered fine particles were subjected to a drying treatment at 110° C. for one hour, and a surface-modified vanadium dioxide-containing particle 108 was obtained.

(9) Preparation of Vanadium Dioxide-Containing Particle 109

A vanadium dioxide-containing particle 109 was prepared in the similar manner as in the preparation of vanadium dioxide-containing particle 107 except that after the heating at 100° C. for 8 hours, the hydrothermal reaction treatment conditions were set to 220° C. and 120 hours.

(10) Preparation of Vanadium Dioxide-Containing Particle 110

A vanadium dioxide-containing particle 110 was prepared in the similar manner as in the preparation of vanadium dioxide-containing particle 108 except that after the heating at 100° C. for 8 hours, the hydrothermal reaction treatment conditions were set to 220° C. and 72 hours.

(11) Preparation of Vanadium Dioxide-Containing Particle 111

A vanadium dioxide-containing particle 111 was prepared in the similar manner as in the preparation of vanadium dioxide-containing particle 102 except that the methyltriethoxysilane was changed to trimethylethoxysilane (manufactured by TOKYO CHEMICAL INDUSTRY CO., LTD.).

(12) Preparation of Vanadium Dioxide-Containing Particle 112

A vanadium dioxide-containing particle 112 was prepared in the similar manner as in the preparation of vanadium dioxide-containing particle 104 except that the methyltriethoxysilane was changed to trimethylethoxysilane (manufactured by TOKYO CHEMICAL INDUSTRY CO., LTD.).

(13) Preparation of Vanadium Dioxide-Containing Particle 113

A vanadium dioxide-containing particle 113 was prepared in the similar manner as in the preparation of vanadium dioxide-containing particle 107 except that after the heating at 100° C. for 8 hours, the hydrothermal reaction treatment conditions were set to 240° C. and 100 hours.

(14) Preparation of Vanadium Dioxide-Containing Particle 114

A vanadium dioxide-containing particle 114 was prepared in the similar manner as in the preparation of vanadium dioxide-containing particle 108 except that after the heating at 100° C. for 8 hours, the hydrothermal reaction treatment conditions were set to 240° C. and 56 hours.

(15) Preparation of Vanadium Dioxide-Containing Particles 115 to 118

Vanadium dioxide-containing particles 115 to 118 were prepared in the similar manner as in the preparation of vanadium dioxide-containing particle 102 except that the methyltriethoxysilane was changed respectively to hexamethyldisilazane (manufactured by TOKYO CHEMICAL INDUSTRY CO., LTD.), tetraisopropyl titanate (manufactured by TOKYO CHEMICAL INDUSTRY CO., LTD.), n-butyl zirconate, and aluminum isopropoxide (manufactured by TOKYO CHEMICAL INDUSTRY CO., LTD.).

(16) Preparation of Vanadium Dioxide-Containing Particles 119 to 122

Vanadium dioxide-containing particles 119 to 122 were prepared in the similar manner as in the preparation of vanadium dioxide-containing particle 104 except that the methyltriethoxysilane was changed respectively to hexamethyldisilazane (manufactured by TOKYO CHEMICAL INDUSTRY CO., LTD.), tetraisopropyl titanate (manufactured by TOKYO CHEMICAL INDUSTRY CO., LTD.), n-butyl zirconate, and aluminum isopropoxide (manufactured by TOKYO CHEMICAL INDUSTRY CO., LTD.).

<<Evaluation of Vanadium Dioxide-Containing Particle>>

### (1) Identification of Product

### (Particle State)

For each prepared vanadium dioxide-containing particle, the shape of vanadium dioxide-containing particle was observed by a scanning electron microscope (SEM, manufactured by JEOL Ltd.), and it was confirmed that the particle was produced.

(Crystal Structure)

For each prepared vanadium dioxide-containing particle, by performing measurement using an X-ray diffraction apparatus (manufactured by Rigaku Corporation), the prepared vanadium dioxide-containing particle was identified by comparing with the profile of the vanadium dioxide crystal composed of a known rutile crystal layer.

(2) Particle Diameter Distribution Measurement

Each prepared vanadium dioxide-containing particle was mixed into water in a concentration of 1% by mass, and the resultant mixture was dispersed for 15 minutes with ultrasonic waves to prepare a sample for measurement.

As to the prepared sample for measurement, the particle diameter D50 of each vanadium dioxide-containing particle was measured by using a laser diffraction particle size analyzer manufactured by Shimadzu Corporation. As the measurement value, a number-based value was used.

The measurement results are shown in Tables 1 and 2.

(3) Measurement of Transmittance Difference (Deterioration Measurement)

Each prepared vanadium dioxide-containing particle was mixed into polyvinyl alcohol so as to be 10% by mass, and a film for measurement having a thickness of 50 μm was prepared.

Each film for measurement was stored at 25° C./50% RH for 24 hours, and then stored at 85° C./85% RH for 24 hours. This was repeated 10 times, and the evaluation of the thermochromic property was performed.

Specifically, each transmittance at a wavelength of 2000 nm at 25° C./50% RH and 85° C./50% RH was measured, and the calculated transmittance difference was evaluated in accordance with the following evaluation criteria. The measurement was performed by a spectrophotometer V-670 (manufactured by JASCO Corporation) equipped with a temperature control unit (manufactured by JASCO Corporation).

The evaluation results are shown in Tables 1 and 2.

⊙: 40% or more

◯: 20% or more to less than 40%

×: less than 20%

TABLE 1

| | | | Surface modification | | | |
|---|---|---|---|---|---|---|
| | | | Surface modifier | | | Presence or |
| | | Hydrothermal | | The | | absence of |
| VO₂ | | reaction | | number of | | ultrafiltration |
| containing | Vanadium | temperature | | functional | Surface modification | (solvent |
| particle No. | compound | (° C.) | Material | groups | time | replacement) |
| 101 | NH₄VO₃ | 270 | Methyltriethoxysilane | 3 | After drying | Absence |
| 102 | NH₄VO₃ | 270 | Methyltriethoxysilane | 3 | During hydrothermal | Absence |
| | | | | | synthesis | |
| 103 | NH₄VO₃ | 270 | Methyltriethoxysilane | 3 | After hydrothermal | Absence |
| | | | | | synthesis | |
| 104 | NH₄VO₃ | 270 | Methyltriethoxysilane | 3 | After hydrothermal | Presence |
| | | | | | synthesis | |
| 105 | NH₄VO₃ | 270 | Dimethyldiethoxysilane | 2 | During hydrothermal | Absence |
| | | | | | synthesis | |
| 106 | NH₄VO₃ | 270 | Dimethyldiethoxysilane | 2 | After hydrothermal | Presence |
| | | | | | synthesis | |
| 107 | V₂O₅ | 270 | Methyltriethoxysilane | 3 | During hydrothermal | Absence |
| | | | | | synthesis | |
| 108 | V₂O₅ | 270 | Methyltriethoxysilane | 3 | After hydrothermal | Presence |
| | | | | | synthesis | |
| 109 | V₂O₅ | 220 | Methyltriethoxysilane | 3 | During hydrothermal | Absence |
| | | | | | synthesis | |
| 110 | V₂O₅ | 220 | Methyltriethoxysilane | 3 | After hydrothermal | Presence |
| | | | | | synthesis | |
| 111 | NH₄VO₃ | 270 | Trimethylethoxysilane | 1 | During hydrothermal | Absence |
| | | | | | synthesis | |
| 112 | NH₄VO₃ | 270 | Trimethylethoxysilane | 1 | After hydrothermal | Presence |
| | | | | | synthesis | |

| | Particle | | | | | |
|---|---|---|---|---|---|---|
| | diameter D50 | Thermochromic property | | | | |
| VO₂ | after surface | Transmittance at | Transmittance at | Transmittance | | |
| containing | modification | 25° C. | 85° C. | difference | | |
| particle No. | (nm) | (%) | (%) | (%) | Evaluation | Remarks |
| 101 | 350 | 65 | 50 | 15 | X | Comparative |
| | | | | | | Example |
| 102 | 70 | 85 | 42 | 43 | ⊙ | Present Invention |
| 103 | 100 | 75 | 40 | 35 | ◯ | Present Invention |
| 104 | 80 | 80 | 38 | 42 | ⊙ | Present Invention |
| 105 | 50 | 90 | 45 | 45 | ⊙ | Present Invention |
| 106 | 65 | 88 | 47 | 41 | ⊙ | Present Invention |
| 107 | 68 | 85 | 44 | 41 | ⊙ | Present Invention |
| 108 | 82 | 79 | 39 | 40 | ⊙ | Present Invention |
| 109 | 70 | 85 | 41 | 44 | ⊙ | Present Invention |
| 110 | 79 | 80 | 37 | 43 | ⊙ | Present Invention |
| 111 | 45 | 93 | 47 | 46 | ⊙ | Present Invention |
| 112 | 60 | 89 | 47 | 42 | ⊙ | Present Invention |

TABLE 2

| | | | Surface modification | | | |
|---|---|---|---|---|---|---|
| | | | Surface modifier | | | Presence or |
| | | Hydrothermal | | The | | absence of |
| VO₂ | | reaction | | number of | | ultrafiltration |
| containing | Vanadium | temperature | | functional | Surface modification | (solvent |
| particle No. | compound | (° C.) | Material | groups | time | replacement) |
| 113 | V₂O₅ | 240 | Methyltriethoxysilane | 3 | During hydrothermal | Absence |
| | | | | | synthesis | |
| 114 | V₂O₅ | 240 | Methyltriethoxysilane | 3 | After hydrothermal | Presence |
| | | | | | synthesis | |
| 115 | NH₄VO₃ | 270 | Hexamethyldisilazane | 1 | During hydrothermal | Absence |
| | | | | | synthesis | |
| 116 | NH₄VO₃ | 270 | Tetraisopropyl titanate | 4 | During hydrothermal | Absence |
| | | | | | synthesis | |
| 117 | NH₄VO₃ | 270 | n-Butyl zirconate | 4 | During hydrothermal | Absence |
| | | | | | synthesis | |
| 118 | NH₄VO₃ | 270 | Aluminum | 4 | During hydrothermal | Absence |
| | | | isopropoxide | | synthesis | |
| 119 | NH₄VO₃ | 270 | Hexamethyldisilazane | 1 | After hydrothermal | Presence |
| | | | | | synthesis | |
| 120 | NH₄VO₃ | 270 | Tetraisopropyl titanate | 4 | After hydrothermal | Presence |
| | | | | | synthesis | |
| 121 | NH₄VO₃ | 270 | n-Butyl zirconate | 4 | After hydrothermal | Presence |
| | | | | | synthesis | |
| 122 | NH₄VO₃ | 270 | Aluminum | 4 | After hydrothermal | Presence |
| | | | isopropoxide | | synthesis | |

| | Particle | | | | | |
|---|---|---|---|---|---|---|
| | diameter D50 | Thermochromic property | | | | |
| VO₂ | after surface | Transmittance at | Transmittance at | Transmittance | | |
| containing | modification | 25° C. | 85° C. | difference | | |
| particle No. | (nm) | (%) | (%) | (%) | Evaluation | Remarks |
| 113 | 68 | 85 | 43 | 42 | ⊙ | Present Invention |
| 114 | 80 | 80 | 36 | 44 | ⊙ | Present Invention |
| 115 | 43 | 95 | 52 | 43 | ⊙ | Present Invention |
| 116 | 74 | 83 | 45 | 38 | ◯ | Present Invention |
| 117 | 75 | 82 | 45 | 37 | ◯ | Present Invention |
| 118 | 75 | 83 | 46 | 37 | ◯ | Present Invention |
| 119 | 46 | 93 | 49 | 44 | ⊙ | Present Invention |
| 120 | 85 | 76 | 40 | 36 | ◯ | Present Invention |
| 121 | 83 | 75 | 38 | 37 | ◯ | Present Invention |
| 122 | 89 | 73 | 39 | 34 | ◯ | Present Invention |

(4) Summary

As shown in Tables 1 and 2, it was confirmed that the vanadium dioxide-containing particle of the present invention has a small particle diameter after the surface modification and is excellent in the transparency and the thermochromic property, as compared with the vanadium dioxide-containing particle in Comparative Example.

From the above, it was understood that as the method for producing a vanadium dioxide-containing particle, producing a vanadium dioxide-containing particle by a hydrothermal reaction, and surface-modifying a surface of the vanadium dioxide-containing particle without separating a solvent and the vanadium dioxide-containing particle can be useful.

### INDUSTRIAL APPLICABILITY

The present invention can be particularly suitably utilized for providing a method for producing a vanadium dioxide-containing particle that is excellent in the thermochromic property and the transparency.

1. A method for producing a vanadium dioxide-containing particle having a thermochromic property by using a hydrothermal reaction, the method comprising
surface-modifying a surface of the vanadium dioxide-containing particle without separating a solvent and the vanadium dioxide-containing particle.

2. The method for producing a vanadium dioxide-containing particle according to claim 1, the method comprising the successive steps of:
preparing a vanadium compound, a reducing agent, water, and a surface modifier; and
mixing the vanadium compound, the reducing agent, the water, and the surface modifier, and producing the vanadium dioxide-containing particle surface-modified by the hydrothermal reaction.

3. The method for producing a vanadium dioxide-containing particle according to claim 1, the method comprising the successive steps of:
preparing a vanadium compound, a reducing agent, and water;
mixing the vanadium compound, the reducing agent, and the water, and producing the vanadium dioxide-containing particle by the hydrothermal reaction; and
returning a reaction system to room temperature, and then mixing a surface modifier to the reaction system, and surface-modifying the surface of the vanadium dioxide-containing particle.

4. The method for producing a vanadium dioxide-containing particle according to claim 1, the method comprising the successive steps of:
preparing a vanadium compound, a reducing agent, and water;
mixing the vanadium compound, the reducing agent, and the water, and producing the vanadium dioxide-containing particle by the hydrothermal reaction;
returning a reaction system to room temperature, and then replacing a solvent by ultrafiltration; and
mixing a surface modifier to the reaction system, and surface-modifying the surface of the vanadium dioxide-containing particle.

5. The method for producing a vanadium dioxide-containing particle according to claim 2, wherein
the number of reactive groups of the surface modifier is 1 or 2.

6. A dispersion comprising a vanadium dioxide-containing particle, wherein
the vanadium dioxide-containing particle is produced by the method for producing a vanadium dioxide-containing particle according to claim 1.

7. A dispersion comprising a vanadium dioxide-containing particle, wherein
the vanadium dioxide-containing particle is produced by the method for producing a vanadium dioxide-containing particle according to claim 2.

8. The method for producing a vanadium dioxide-containing particle according to claim 3, wherein
the number of reactive groups of the surface modifier is 1 or 2.

9. A dispersion comprising a vanadium dioxide-containing particle, wherein
the vanadium dioxide-containing particle is produced by the method for producing a vanadium dioxide-containing particle according to claim 3.

10. The method for producing a vanadium dioxide-containing particle according to claim 4, wherein
the number of reactive groups of the surface modifier is 1 or 2.

11. A dispersion comprising a vanadium dioxide-containing particle, wherein
the vanadium dioxide-containing particle is produced by the method for producing a vanadium dioxide-containing particle according to claim 4.

12. A dispersion comprising a vanadium dioxide-containing particle, wherein
the vanadium dioxide-containing particle is produced by the method for producing a vanadium dioxide-containing particle according to claim 5.
